(19) United States
(12) Patent Application Publication
(10) Pub. No.: US 2014/0317347 A1
(43) Pub. Date: Oct. 23, 2014

(54) SYSTEM AND METHOD FOR LOGICAL REMOVAL OF PHYSICAL HEADS IN A HARD DISK DRIVE (HDD)

(71) Applicant: HGST Netherlands B.V., Amsterdam (NL)

(72) Inventors: Toru AIDA, Sagamihara-shi (JP); Ryoji FUKUHISA, Tokyo (JP); Toshiyuki KONISHI, Odawara-shi (JP); Daiki NAGAKURA, Fujisawa-shi (JP); Mariko SAITO, Fujisawa-shi (JP); Toshiroh UNOKI, Fujisawa-shi (JP); Yuji YOKOE, Yokohama-shi (JP)

(73) Assignee: HGST Netherlands B.V., Amsterdam (NL)

(21) Appl. No.: 14/185,087

(22) Filed: Feb. 20, 2014

Related U.S. Application Data
(60) Provisional application No. 61/814,453, filed on Apr. 22, 2013.

(51) Int. Cl. G06F 3/06

(52) U.S. Cl. CPC G06F 3/0689; G06F 3/0619; G06F 3/0665
USPC 711/114

(57) ABSTRACT

A hard disk drive (HDD) provides for the logical removal of defective physical heads. The HDD includes one or more disks organized into a plurality of regions, each region having a plurality of physical block addresses (PBAs). A number of physical heads are used to read and write information to the disks. A controller is configured to translate logical block addresses (LBAs) received from an external system to PBAs used to access the one or more disks, wherein the controller is configured to logically remove a defective physical head from service by dynamically re-assigning LBAs to each of the plurality of regions while preventing LBAs from being assigned to regions associated with the defective physical head.

### CROSS-REFERENCE TO RELATED APPLICATION

This application claims the benefit of U.S. provisional application No. 61/814,453, filed on 22 Apr. 2013, the entire contents of which are incorporated herein by reference. A claim of priority is made.

### TECHNICAL FIELD

This disclosure relates to hard disk drive (HDD) systems, and in particular to a logical method of removing defective physical heads from use within the HDD system.

### BACKGROUND

Large data storage facilities, such as those used to implement “cloud storage” applications, utilize a plurality of redundant hard disk drive (HDD) systems. In response to a HDD failure, the failed unit is replaced while the overall system remains online. Because the data is stored redundantly, the HDDs are consumed as “fuel” for the data storage facility. The “fuel” costs associated with data storage facilities is defined by the number of HDDs that must be replaced.

There are several methods of reducing these “fuel” costs. For example, HDD reliability may be improved, thereby reducing the number of HDDs that must be replaced annually. Alternatively, rather than replace a HDD in response to an error, the damaged portion of the HDD may be eliminated while continuing to utilize usable capacity of the HDD. For example, a HDD includes a plurality of disks, and one or more physical heads associated with each disk to enable read and write operations to the disk. If one of the physical heads fails, the portion of the HDD associated with the failed physical head is lost, but the remainder of the HDD system associated with the remaining physical heads remains useful. The effectiveness of this approach depends on how easily the failed physical head can be eliminated and how quickly the remainder of the HDD system can be brought back online.

### SUMMARY

A method of logically removing a defective physical head from service in a hard disk drive (HDD) system includes (a) selecting a current region from a region array. The method further includes (b) determining whether the current region is associated with the defective physical head. If the current region is not associated with the defective physical head then the method assigns a next available logical block address (LBA) range to the current region by updating the region array and updates a region chain of a previous region assigned an LBA range in the region array with the location of the current region. the method increments the current region and repeating steps (a) and (b) for all available regions.

A storage device includes a magnetic media, a plurality of physical heads, and a indirection controller. The magnetic media includes one or more disks for storing data, wherein the magnetic media is organized into a plurality of regions, each region having a plurality of physical block addresses (PBAs). The plurality of physical heads write information to and read information from the magnetic media, each physical head associated with selected regions within the plurality of regions. The indirection controller translates LBAs received from an external system to PBAs, wherein the indirection controller is configured to logically remove a defective physical head from service by dynamically re-assigning LBAs to each of the plurality of regions while preventing LBAs from being assigned to regions associated with the defective physical head.

A computer readable storage medium containing instructions for logically removing a physical head from being utilized in a hard disk drive (HDD) system, wherein execution of the program instructions by one or more processors of a computer system causes the one or more processors to carry out the steps of includes (a) selecting a current region from a region array and (b) determining whether the current region is associated with the defective physical head. If the current region is not associated with the defective physical head then the next available LBA range is assigned to the current region by updating the region array, and updating a region chain parameters of a previous region assigned an LBA range in the region array with the location of the current region. The current region is incremented and the steps are repeated for all available regions.

### BRIEF DESCRIPTION OF THE DRAWINGS

FIG. 1 is a block diagram of a hard disk drive (HDD) system according to an embodiment of the present invention.

FIGS. 2A-2B are block diagrams illustrating logical removal of a physical head in a hard disk drive (HDD) system according to an embodiment of the present invention.

FIG. 3 is a flowchart of a method of logically removing a physical head from service according to an embodiment of the present invention.

### DETAILED DESCRIPTION

The hard disk drive (HDD) system disclosed herein provides for the logical removal of physical heads. In particular, the HDD system utilizes an indirection addressing architecture to dynamically re-assign logical addresses to physical addresses, while preventing logical addresses from being assigned to physical addresses associated with defective physical heads.

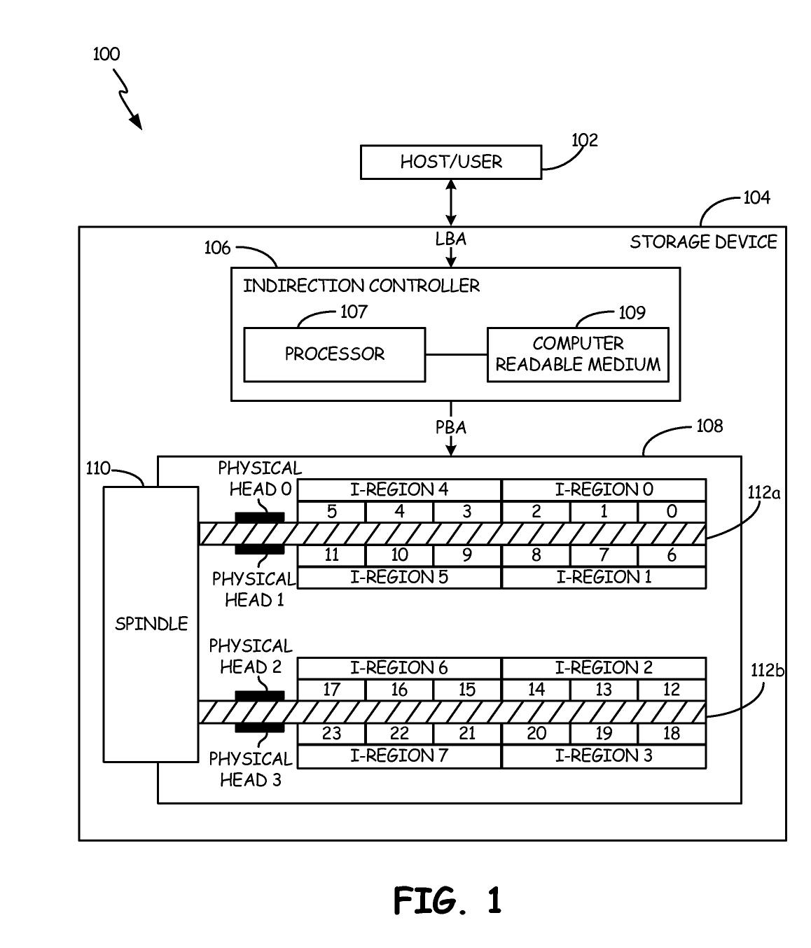

FIG. 1 is a block diagram of computer system 100 according to an embodiment of the present invention, which includes host/user system 102 and storage device 104. For example, host/user system 102 may be a processor, an independent computer system, a server system, or other hardware component that communicates with magnetic storage device 104. In the embodiment shown in FIG. 1, magnetic storage device 104 includes indirection controller 106 and hard disk components 108. Indirection controller 106 includes processor 107 and computer readable medium 109. Processor 107 may be a programmable logic controller (PLC), micro-processor or micro-controller. Computer readable medium 109 may be separate from hard disk components 108 or refer to space reserved within hard disk component 108 for storing data structures and/or instructions for execution by processor 107 to perform the logical removal of physical heads from hard disk drive (HDD) 100. Hard disk components 108 include spindle 110, magnetic disks 112a and 112b, and physical heads labeled physical head #0, physical head #1, physical head #2, and physical head #3.

Indirection controller 106 provides a dynamic translation layer between logical block addresses (LBAs) utilized by host/user system 102 and physical blocks addresses (PBAs) used to access data stored to disks 112a and 112b. That is, indirection controller 106 manages the assignment of LBAs to PBAs. In a conventional system, mapping LBAs to PBAs remains relatively static because individual tracks can be re-written at any time. In more complex architectures, such as those employing shingled magnetic recording (SMR) or indirection-based perpendicular magnetic recording (PMR), the mapping between LBAs and PBAs can change with every write operation because the system dynamically determines the physical location (i.e., PBA) assigned a particular logical location (i.e., LBA). The data for the same LBA will be written to a different location the next time the host LBA is updated. In this way, indirection controller 106 provides a dynamic translation layer between LBAs provided by host/user system 102 and PBAs associated with hard disk components 108.

In the embodiment shown in FIG. 1, magnetic disks 112a and 112b are mounted to spindle 110. Each magnetic disk 112a and 112b includes a top surface and a bottom surface. Physical head #0 is associated with the top surface of magnetic disk 112a, physical head #1 is associated with the bottom surface of magnetic disk 112a, physical head #2 is associated with the top surface of magnetic disk 112b, and physical head #3 is associated with the bottom surface of magnetic disk 112b.

Tracks associated with magnetic disks 112a and 112b are divided into a plurality of regions. Those regions utilized to store customer data are referred to as “I-regions” and are labeled in FIG. 1 as I-regions 0-7. In some architectures, such as shingled magnetic recording, additional regions known as “E-regions” may be used to temporarily store write data until it can be written to a permanent location in I-regions 0-7. However, in other applications such as indirection perpendicular magnetic recording (iPMR), no additional regions are utilized. In addition, magnetic disks 112a and 112b are further sub-divided into a plurality of physical block addresses (PBAs) 0-23. For example, PBA 0 is located on the top surface of magnetic disk 112a, is accessed via physical head #0 and is included as part of I-region 0.

Indirection controller 106 is responsible for managing the assignment of LBAs to the plurality of PBAs. As part of this responsibility, indirection controller 106 maintains a region array data structure to manage the assignment of logical addresses to physical addresses. In one embodiment, the data structure is a region array that includes an entry for each of the plurality of regions (e.g., I-regions 0-7). For each entry (e.g., I-region 0), the array would include PBA range, LBA range, and pointers (e.g., region chains) that identify successive regions to traverse based on LBA assignment.

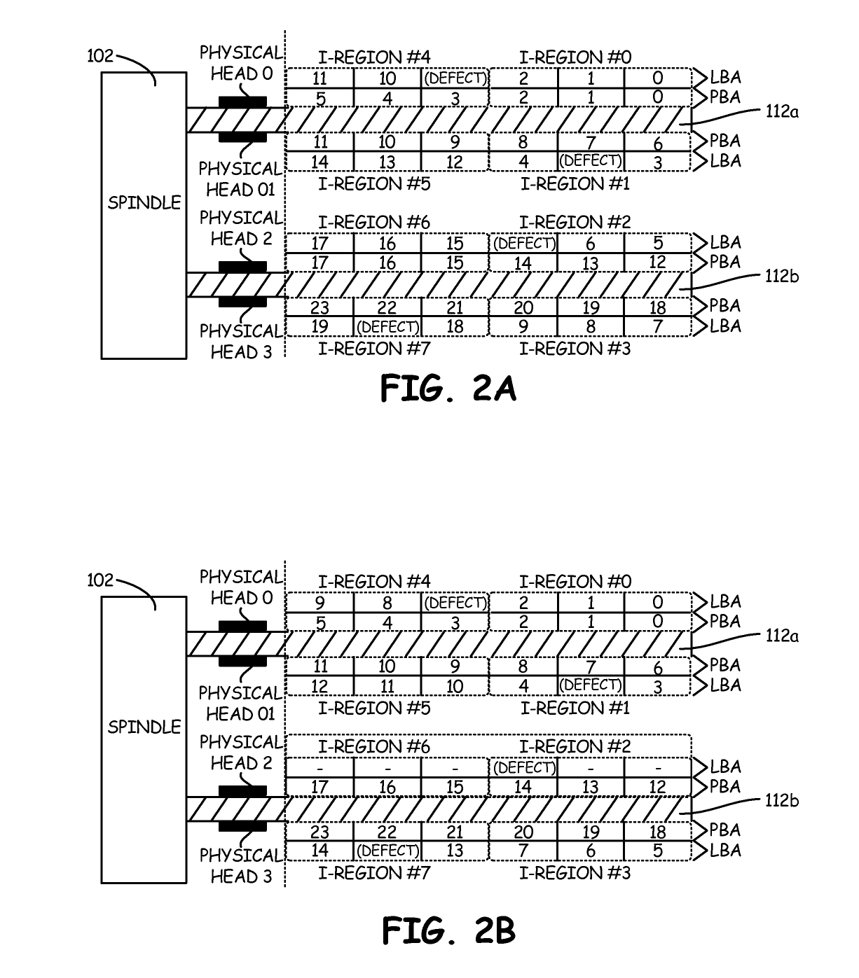

FIGS. 2A-2B are block diagrams illustrating logical head removal in a magnetic storage device system 104 according to an embodiment of the present invention. As described with respect to FIG. 1, hard disk components 108 include spindle 110, magnetic disks 112a and 112b, and a plurality of physical heads #0-3. In the embodiment shown in FIG. 2A, indirection controller 106 (shown in FIG. 1) has assigned LBAs to PBAs. In both FIGS. 2A and 2B, PBA assignment is illustrated by addresses located adjacent to magnetic disks 112a and 112b, while LBA assignment is illustrated by addresses located adjacent to PBAs. For example, LBA 3 has been assigned to PBA 6, which is located in I-region 1. A request received by indirection controller 106 (shown in FIG. 1) regarding LBA 3 is therefore directed by controller 106 to PBA 6.

For the embodiment shown in FIG. 2A, indirection controller 106 (shown in FIG. 1) maintains a region array (shown below) that identifies the mapping between I-regions, LBAs, and PBAs. The region array is typically stored to a reserved region of one or more of the disks 112a and 112b.

TABLE 1
Region Array

| | LBA | | | |
|---|---|---|---|---|
| I-Region # | Range | PBA Range | Physical Head # | Region Chain |
| 0 | 0-2 | 0-2 | 0 | 1 |
| 1 | 3-4 | 6-8 | 1 | 2 |
| 2 | 5-6 | 12-14 | 2 | 3 |
| 3 | 7-9 | 18-20 | 3 | 4 |
| 4 | 10-11 | 3-5 | 0 | 5 |
| 5 | 11-13 | 9-11 | 1 | 6 |
| 6 | 14-16 | 15-17 | 2 | 7 |
| 7 | 17-18 | 21-23 | 3 | — |

As discussed above, the region array is organized by I-regions 0-7 and stores parameters associated with each region, including LBA range assigned to the regions, PBA range assigned to each region, physical head used to access the region, and region chain. In particular, the region chain identifies with respect to a given region the region assigned the successive LBAs. In this way, region chain allows the regions to be traversed quickly to find a desired LBA.

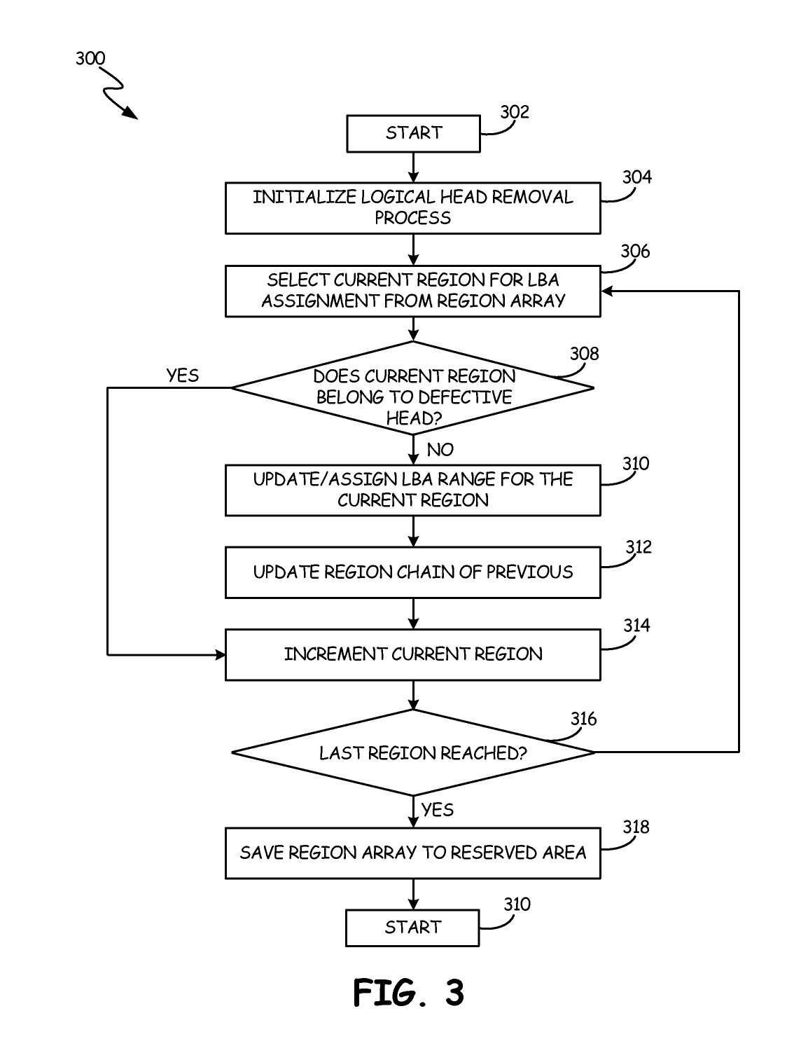

FIG. 2B illustrates the assignment of LBAs by indirection controller 106 following identification of physical head #2 as defective. In response, indirection controller 106 (shown in FIG. 1) re-assigns LBAs based on the unavailability of PBAs associated with physical head #2. As shown in FIG. 2B, this does not include any re-assignment of PBAs, only LBAs. As a result, indirection controller 106 provides a “logical” removal of physical head #2 from service. As such, the process does not require firmware parameters to be modified and updated to re-assign PBAs to different physical heads. As discussed in more detail with respect to FIG. 3, indirection controller 106 modifies the region array, as indicated below, to achieve a logical removal of physical head #2.

TABLE 2
Region Array

| | LBA | | | |
|---|---|---|---|---|
| I-Region # | Range | PBA Range | Physical Head # | Region Chain |
| 0 | 0-2 | 0-2 | 0 | 1 |
| 1 | 3-4 | 6-8 | 1 | 3 |
| 2 | — | 12-14 | 2 | — |
| 3 | 5-7 | 18-20 | 3 | 4 |
| 4 | 8-9 | 3-5 | 0 | 5 |
| 5 | 10-12 | 9-11 | 1 | 7 |
| 6 | — | 15-17 | 2 | — |
| 7 | 13-14 | 21-23 | 3 | — |

As discussed above, the modification of the region array does not include re-assignment of PBAs. For example, even though physical head #2 is defective, PBA range 12-14 and 15-17 remains assigned to physical head #2. However, the LBA ranges previously assigned to PBA range 12-14 and 15-17 have been re-assigned to other PBA ranges. Therefore, with respect to I-region 2 and 7 (associated with defective physical head #2), no LBAs are assigned to these regions. In addition, region chain has been updated to correctly traverse the regions in order of ascending LBA addresses.

FIG. 3 is a flowchart of method 300 implemented by indirection controller 106 to logically remove a physical head from service according to an embodiment of the present invention. The method implemented by controller 106 may be implemented by processor 107 (shown in FIG. 1) executing instructions stored on computer readable medium 109 (also shown in FIG. 1).

The method starts at step 302 with the identification of a defective physical head. A number of methods may be utilized to detect defective physical heads, any one of which may be utilized herein.

At step 304, a number of parameters associated with the logical head removal process are initialized to begin the re-assignment process. In some embodiments, the region array (or equivalent data structure) remains populated with LBA, PBA, and region chain parameters. Logical head removal therefore includes traversal of each region in the region array in ascending order with updates made to each entry in the region array until all regions have been analyzed. Therefore, a region index value (identifying the current region to be examined) would be initialized at this step to a value of 0 to ensure that the process begins with the first region in the region array. Other parameters that require initialization include the address of the first LBA to be assigned, as well as parameters associated with region chains.

At step 306, a current region is selected from the region array for LBA assignment based on the region index value. For example, following initialization at step 306, in which region index is set equal to zero, the current region selected at step 306 will be the first region in the region array (i.e., I-region 0). In the steps following steps 306, parameters associated with the region array are modified to logically remove one or more defective physical heads from use.

At step 308, a determination is made whether the current region is associated with the physical head to be logically removed. For example, if physical head #0 were identified as defective, then the current region (e.g., I-region 0) would be identified as associated with a defective physical head. If the current region is associated with a physical head to be logically removed, then no LBAs are assigned to the current region and the method continues at step 314 with the incrementing of the region index. As a result, no LBAs are assigned to this region. In one embodiment, this requires the LBA range associated with the region to be set to null, while in other embodiments all LBA ranges are set to null during the initialization and is simply left as a null value. If the current region is not associated with a physical head to be logically removed, then at steps 310 and 312 LBAs are assigned to the current region and the region array is updated to reflect the LBA assignment.

In particular, at step 310 a range of LBAs are assigned to the current region. This step may additionally include making a determination of the size of the region (i.e., the number of PBAs that can be assigned LBAs). This determination of region size accounts for defective PBAs within the region. For example, in the embodiment shown in FIGS. 2A and 2B, for I-region 0 the region size would be identified as three because all three PBAs are available for LBA assignment. However, in I-region 4 one of the PBAs is defective, such that only two PBAs are available for assignment and thus the size of the region is two and not three. In one embodiment, this determination is made based on the range of LBA's previously assigned to the region. Once the size of the region is known, a range of LBAs are assigned to the PBAs associated with the current region.

At step 312, the region chain associated with the previous region assigned LBAs is updated to point to the current region. For example, in region array shown in Table 2, if I-region 3 is the current region, then I-region 1 would be the previous region because this was the last I-region to which LBAs were assigned (i.e., no LBAs were assigned to I-region 2 because physical write head #2 was defective). In this way, the region chain associated with the previous region (e.g., I-region 1) is updated in the region array to correctly point to the current region (e.g., I-region 3).

At step 314 the region index is incremented to select the next available region as the current region. For example, if region index is equal to 1 (thereby selecting I-region 1) then incrementing the region index results in I-region 2 being selected as the next “current” region.

At step 316 a determination is made regarding whether all regions have been assigned LBAs. In one embodiment, this includes comparing the current region index to the number of known regions available for assignment. If all regions have been assigned LBAs then at step 318 the region array (completed with LBA assignments and region chains) is saved by indirection controller 106 and the method ends at step 320. In one embodiment, region array is saved to a reserved memory location.

If at step 316 it is determined that additional regions remain for LBA assignment, then the method continues at step 306, wherein the current region (incremented at step 314) is selected for LBA assignment. The method continues until all regions have been assigned LBAs. However, because those regions associated with defective physical heads are not assigned LBAs, the method results in the logical removal of those physical heads from service even though the PBAs remain associated with the defective physical heads.

In this way, indirection controller 106 is capable of logically removing a defective physical head from use. Because the logical removal of the defective physical head does not require re-mapping of physical block addresses, defective physical heads can be logically removed quickly, allowing the remaining usable portion of hard disk drive (HDD) to be returned to operational status quickly.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of logically removing a defective physical head from service in a hard disk drive (HDD) system, the method comprising:
a. selecting a current region from a region array;
b. determining whether the current region is associated with the defective physical head;
wherein if the current region is not associated with the defective physical head then:
c. assigning next available logical block address (LBA) range to the current region by updating the region array;
d. updating a region chain of a previous region assigned an LBA range in the region array with the location of the current region; and
e. incrementing the current region and repeating steps a.)-d.) for all available regions.

2. The method of claim 1, determining whether the current region is associated with the defective physical head includes comparing a physical head value stored in the region array for the current region.

3. The method of claim 1, wherein assigning the next available LBA range to the current region includes determining a size of the current region that represents a number of physical block addresses that can be assigned LBAs.

4. The method of claim 1, further including saving the region array to a reserved area after all regions in the region array have been analyzed for LBA assignment.

5. A storage device comprising:
a magnetic media having one or more disks for storing data, wherein the magnetic media is organized into a plurality of regions, each region having a plurality of physical block addresses (PBAs);
a plurality of physical heads that write information to and read information from the magnetic media, each physical head associated with selected regions within the plurality of regions; and
a controller configured to translate logical block addresses (LBAs) received from an external system to (PBAs), wherein the controller is configured to logically remove a defective physical head from service by dynamically re-assigning LBAs to each of the plurality of regions while preventing LBAs from being assigned to regions associated with the defective physical head.

6. The storage device of claim 5, wherein the controller maintains a region array that identifies each of the plurality of regions, LBA ranges associated with each of the plurality of regions, PBA ranges associated with each of the plurality of regions, a physical head associated with each of the plurality of regions, and a region chain value that links the plurality of regions together in order of ascending LBA ranges assigned to each region.

7. The storage device of claim 6, wherein during logical removal of the defective physical head the controller updates the region array to reflect the re-assignment of the LBAs to each of the plurality of regions.

8. The storage device of claim 7, wherein during logical removal of the defective physical head, the controller updates the region chain values to skip those regions not assigned one of the LBA ranges.

9. The storage device of claim 6, wherein the update region array is stored to a reserved area of the magnetic media by the controller when all regions in the region array have been updated.

10. A computer readable storage medium containing instructions for logically removing a physical head from being utilized in a hard disk drive (HDD) system, wherein execution of the program instructions by one or more processors of a computer system causes the one or more processors to carry out the steps of:
a. selecting a current region from a region array;
b. determining whether the current region is associated with the defective physical head;
wherein if the current region is not associated with the defective physical head then:
c. assigning a next available logical block address (LBA) range to the current region by updating the region array;
d. updating a region chain of a previous region assigned an LBA range in the region array with the location of the current region; and
e. incrementing the current region and repeating steps a.)-d.) for all available regions.

11. The computer readable storage medium of claim 10, wherein the step of determining whether the current region is associated with the defective physical head includes comparing a physical head value stored in the region array for the current region.

12. The computer readable storage medium of claim 10, wherein assigning the next available LBA range to the current region includes determining a size of the current region that represents a number of physical block addresses that can be assigned LBAs.

13. The computer readable storage medium of claim 10, further including saving the region array to a reserved area after all regions in the region array have been analyzed for LBA assignment.
